(19) United States
(12) Patent Application Publication
(10) Pub. No.: US 2011/0052298 A1
(43) Pub. Date: Mar. 3, 2011

(54) APPARATUS FOR FEEDING, TAKING UP AND DUPLEXING

(76) Inventors: Gianni Cessel, Rubi SP (ES); Fernando Juan Jover, Viladecavalls (ES); Martin Urrutia Nebreda, Barcelona (ES)

(21) Appl. No.: 12/553,872

(22) Filed: Sep. 3, 2009

(51) Int. Cl. B41J 15/00; B41J 11/00

(52) U.S. Cl. 400/613; 400/621

(57) ABSTRACT

In one embodiment, an apparatus to feed or take up media comprises a drum axis, a drum connecting to the drum axis, three spindles connecting to the drum, and a reel removably connecting to one of the three spindles. The drum holds the spindles and rotates around the drum axis to position the spindles, each spindle to hold a media roll or a reel to feed or take up media.

### BACKGROUND

Printing devices that print on media rolls may utilize a reel or another take-up device to collect the media after printing. Such a printing device may be adapted to allow for the loading of multiple media types and sizes by adding a separate multi-roll feeding accessory. A media roll printing device may also be adapted to allow for printing on both sides of media (“duplexing”) by adding a separate duplexer accessory.

### BRIEF DESCRIPTION OF THE DRAWINGS

The accompanying drawings illustrate various embodiments and are a part of the specification. The illustrated embodiments are merely examples and do not limit the scope of the claims. Throughout the drawings, identical reference numbers designate similar, but not necessarily identical elements.

FIG. 1 is a diagram of a printing device that incorporates an embodiment of an apparatus for feeding, taking up and duplexing.

FIG. 2 is a cross section diagram of the printing device and apparatus of FIG. 1.

FIG. 3 is a cutaway diagram of one embodiment of an apparatus for feeding, taking up and duplexing, with one drum end partially removed to display the spindles.

FIG. 4 is a cutaway diagram of the apparatus of FIG. 3, illustrating detail of a drum end, a drum actuator, and a spindle actuator.

FIG. 5 is cutaway diagram of the apparatus of FIG. 3, illustrating additional detail of a spindle actuator and a first spindle motor.

FIG. 6 is a cross-section diagram of the apparatus of FIG. 3, illustrating a spindle in a loading/unloading position.

FIG. 7 is a cross-section diagram of the apparatus of FIG. 3, illustrating a media path.

FIG. 8 is a cutaway diagram of the apparatus of FIG. 3, illustrating a cutter.

FIG. 9 is a block diagram of the apparatus of FIG. 3.

FIG. 10 is a block diagram of the apparatus of FIG. 3, illustrating a drum motor interface, a first spindle motor interface, and a second spindle motor interface.

FIG. 11 is a flow chart of one embodiment of a method for feeding, taking up and duplexing.

The same part numbers designate the same or similar parts throughout the figures.

### DETAILED DESCRIPTION OF EMBODIMENTS

Adding accessories to provide take up, multi-roll feeding and duplexing function in a printing device may not be a viable option for many users due to space limitations and expense. Embodiments of the apparatus for feeding, taking up and duplexing were developed in an effort to provide a single device that provides multi-roll feeding, taking up and duplexing functionality in a printing device, and to thereby reduce the expense and space limitations previously associated with such functionality. Embodiments are described with reference to a printing device. The embodiments shown in the accompanying drawings and described below, however, are non-limiting examples. Other embodiments are possible and nothing in the accompanying drawings or in this Detailed Description of Embodiments should be construed to limit the scope of the disclosure, which is defined in the Claims.

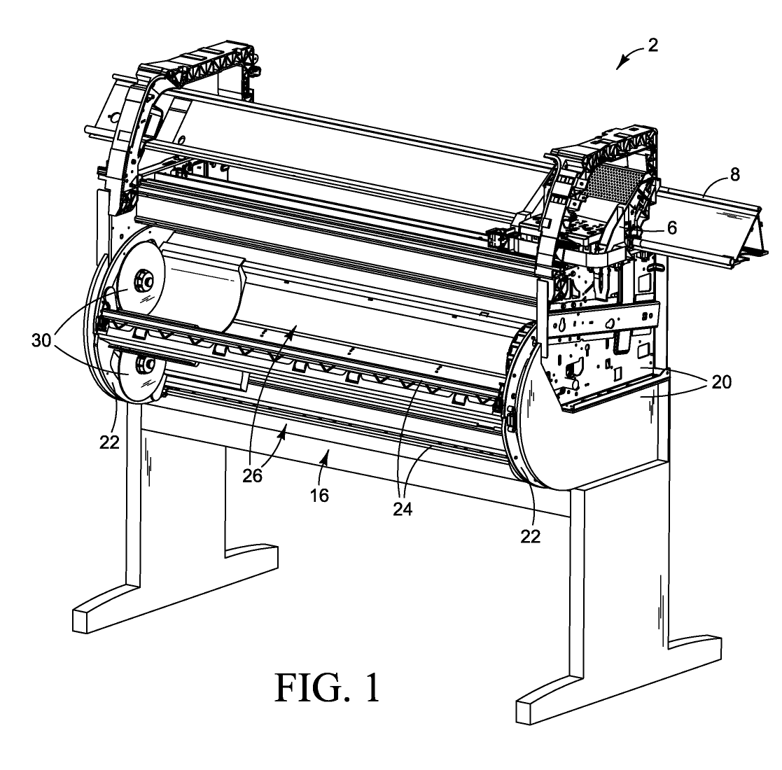

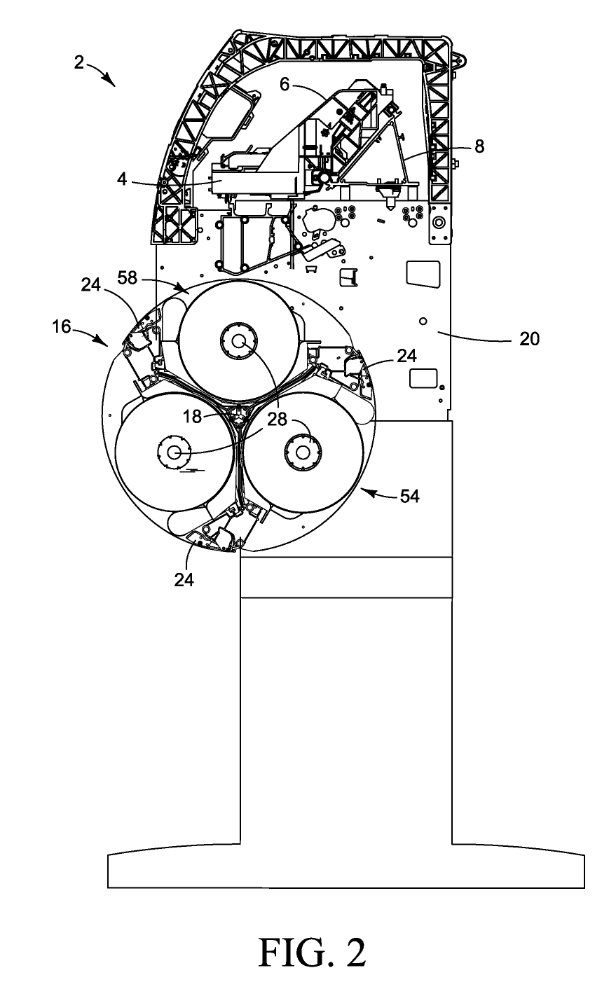

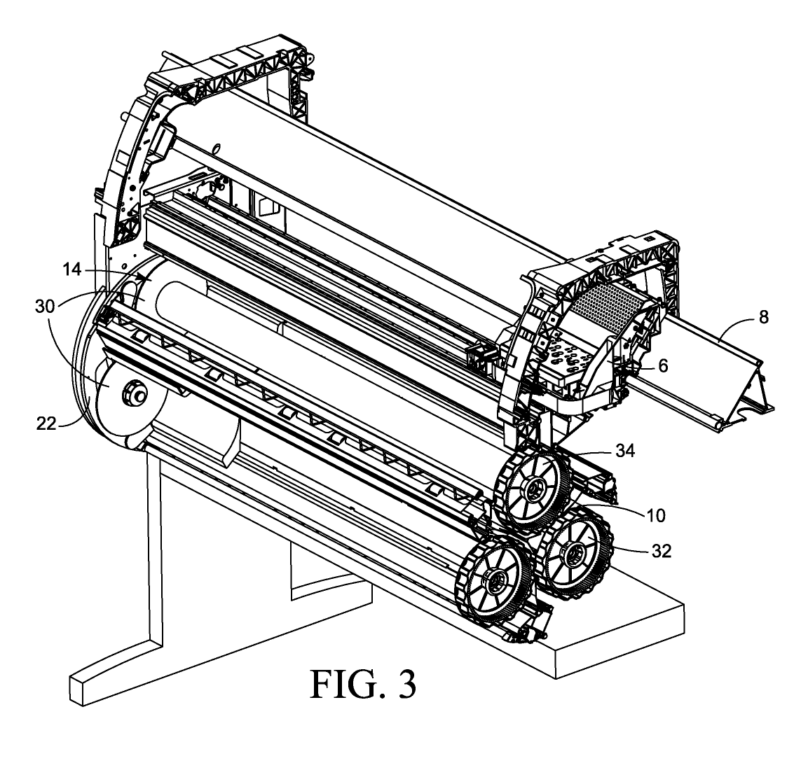

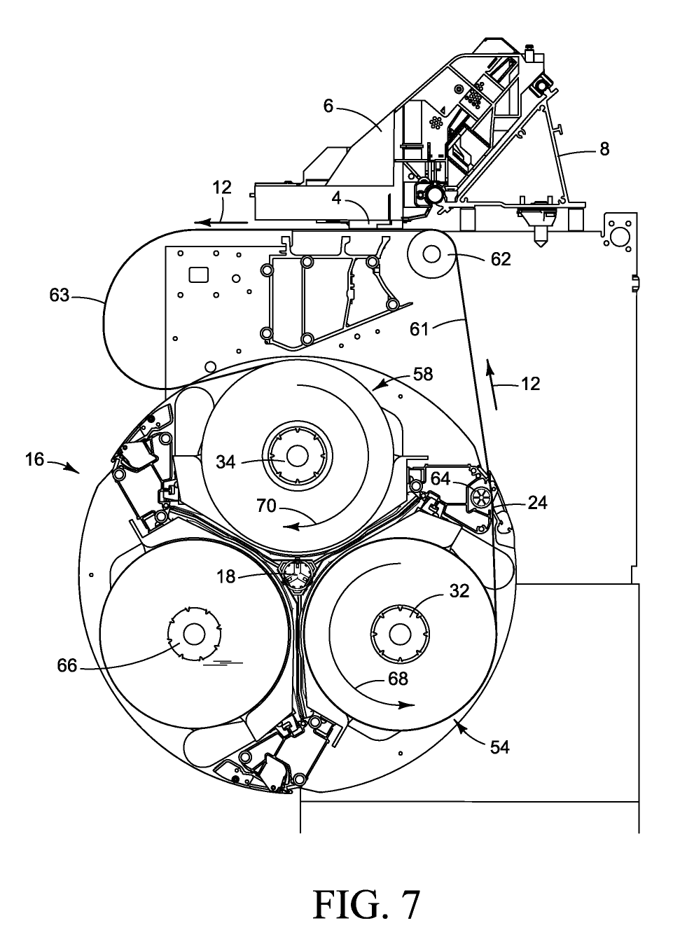

FIG. 1 is a diagram of a printing device that incorporates an embodiment of an apparatus for feeding, taking up and duplexing. FIG. 2 is a cross section diagram of the printing device and the apparatus of FIG. 1. The exemplary printing device 2 includes a thermal system inkjet printhead 4 that attaches to a carriage 6, which carriage 6 can travel back and forth on a scan axis 8. In the exemplary embodiment the printhead 4, the carriage 6 and the scan axis 8 are positioned at the top of the printing device 2, and media 61 (FIG. 7) is moved from a media roll 10 (FIG. 3) through a media path 12 (FIG. 7) so as to pass under the printhead 4. As the printhead 4 travels back and forth over the media 61 beneath it, the printhead 4 can eject ink drops in precise patterns so as to print an image onto the side of the media 61 facing the printhead 4. Printed-upon media 63 (FIG. 7) is moved along the media path 12 away from the printhead 4 to be taken up on a reel 14 (FIG. 3).

In an exemplary embodiment an apparatus for feeding, taking up and duplexing the media includes a drum 16 that connects to a drum axis 18, the drum 16 for rotating around the drum axis 18. The drum axis 18 connects to the chassis 20 of the printing device 2 and may be mounted at an approximately horizontal orientation. The exemplary drum 16 includes two drum ends 22, and three bails 24 that separate the interior of the drum 16 into three bays 26.

In an embodiment each of the three bays 26 includes a spindle 28 that connects to one end of the drum 16, with each of the three spindles 28 positioned on the drum 16 approximately equidistant from the drum axis 18 and approximately equidistant from adjacent spindles 28. Each spindle 28 is configured to removably hold a media roll 10 containing media 61 that may be fed through a media path 12 to the printhead 4. Each spindle 28 is also configured to removably hold a reel 14 that can take up printed-upon media 63 from the media path 12 after printing, or to be used to feed media 61 in a duplexing operation.

In the exemplary embodiment in each bay 26, connecting to the opposite end of the drum 16, there is a rotating member 30. The rotating member removably connects to and holds a media roll 10 or a reel 14, and is driven by the media roll 10 or reel 14 so that the rotating member 30 rotates in concert with the spindle 28. As used in this specification and the appended claims, “holding” includes supporting, positioning, and assisting in supporting or positioning. For example a spindle 28 is said to be “holding” a media roll 10 or a reel 14 in the case where a spindle 28 and a rotating member 30 are working together to support or position a media roll 10 or a reel 14.

In another embodiment, a spindle may include a left and right end for removably holding the ends of a media roll 10 or reel 14, with each end of the spindle connecting to one of two drum ends 22. In such an embodiment the spindle may include a connecting structure that extends along the length of a bay 26 and connects the spindle's left end and right end. A media roll 10 or reel 14 might rotate around the connecting structure. In such an embodiment, a rotating member would not be incorporated as the spindle structure spans the length of the bay 26 and the spindle provides two anchor points for a media roll 10 or reel 14.

FIG. 3 is a cutaway diagram of one embodiment of an apparatus for feeding, taking up and duplexing, with one drum end partially removed to display the spindles. In the exemplary embodiment the apparatus includes a drum 16, the drum 16 including a drum end 22 that holds three spindles 28. FIG. 3 illustrates three spindles, one holding a media roll 10, one holding a reel 14, and one not holding a media roll 14 or reel 10.

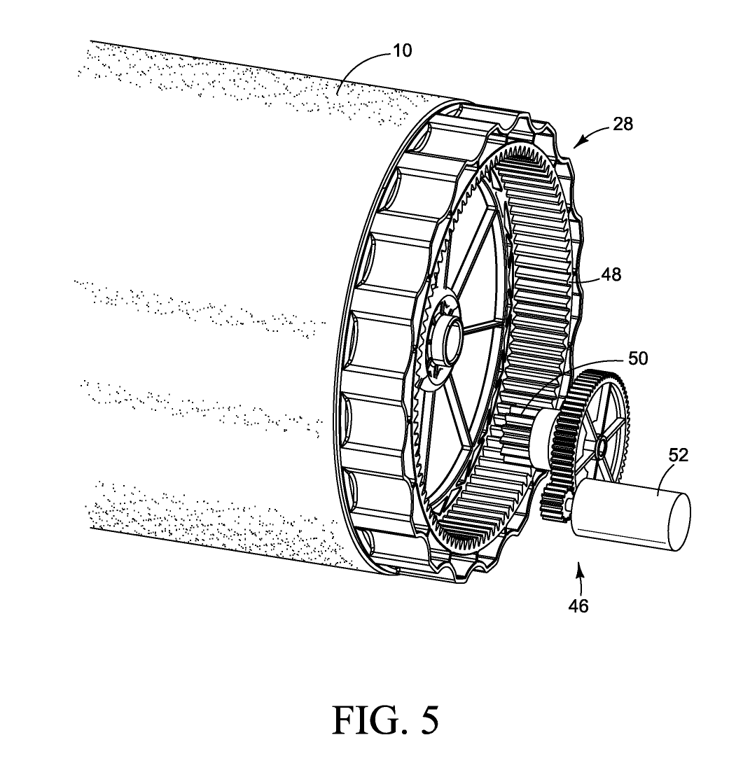

In the exemplary embodiment, the apparatus also includes three complementary rotating members 30, each connecting to a drum end 22 opposite of the drum end 22 that connects to the three spindles 28 (the drum end 22 that connects to the three spindles 28 is not shown in FIG. 3). Each of the three complementary rotating members 30 can removably connect to and hold a media roll 10 or a reel 14 that is being held by an associated spindle 28. When a spindle 28 holds a media roll 10 or reel 14 and is rotated by a spindle actuator 46 (FIG. 5), the associated complementary rotating member 30 rotates in concert with the spindle 28.

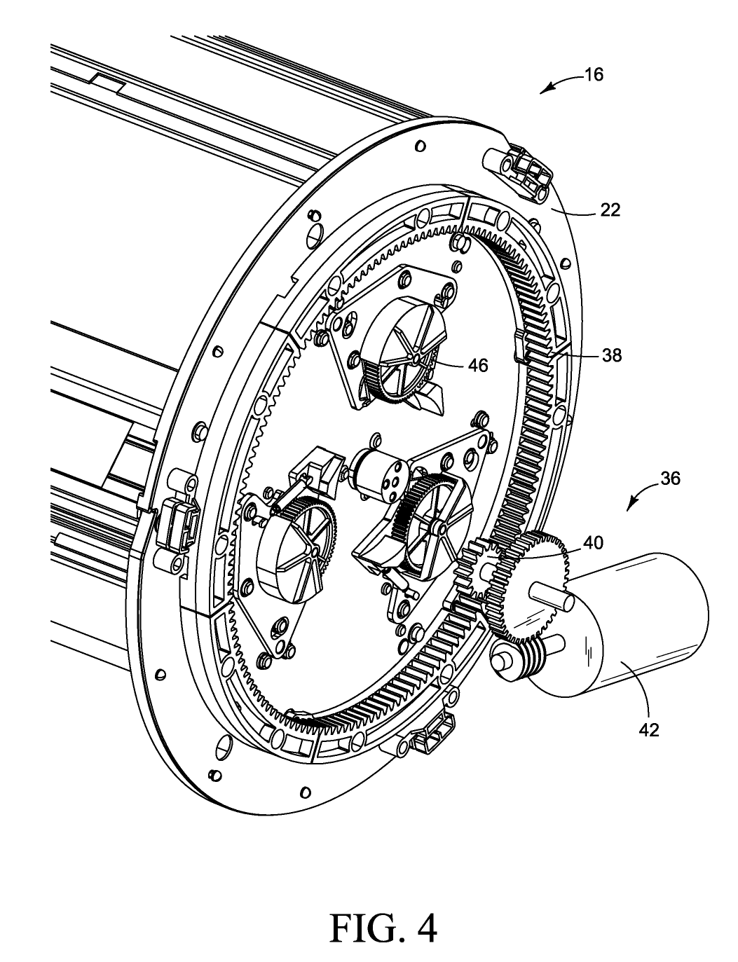

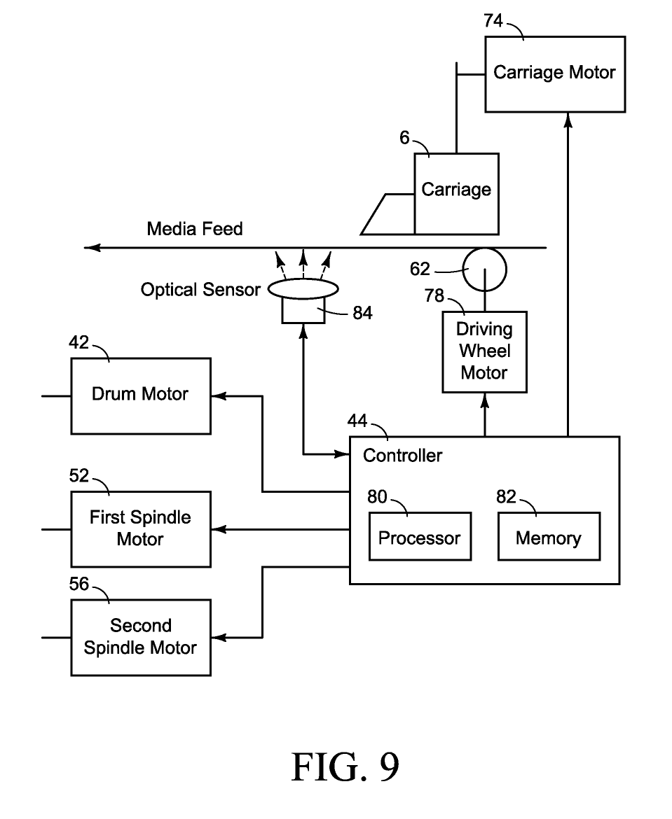

FIG. 4 is a cutaway diagram of the apparatus of FIG. 3, illustrating detail of a drum end, a drum actuator, and a spindle actuator. FIG. 5 is cutaway diagram of the apparatus of FIG. 3, illustrating additional detail of a spindle actuator and a first spindle motor. In an embodiment a drum actuator 36 may include a circular rack 38 that attaches to the drum end 22, a pinion 40 that engages the circular rack 38, and a drum motor 42 that attaches to the chassis 20 (FIG. 1) and engages the pinion 40. Movement of the drum actuator 36 may be controlled by one or more controllers 44 (FIG. 9) that electronically connect to the drum motor 42. In an embodiment, the drum actuator 36 can rotate the drum 16 in either a clockwise or a counterclockwise direction.

In an embodiment, three spindle actuators 46 (one for each of three spindles 28) attach one of the two drum ends 22. Each spindle actuator 46 includes a circular rack 48 that attaches to the end of the spindle 28, and a pinion 50 that engages the circular rack 48. A first spindle motor 52 is attached to the chassis 20 such that the first spindle motor 52 can engage any of the three spindle actuators 46 when the spindle 28 that connects to that spindle actuator 46 is in a feeding position 54 (FIG. 2). As used in this specification and the appended claims, “feeding position” means a spindle position for moving media off of a media roll and through a media path for printing. Likewise, a second spindle motor 56 (FIG. 9) is attached to the chassis 20 such that the second spindle motor 56 can engage any of the three spindle actuators 46 when the spindle 28 that connects to that spindle actuator 46 is in a take-up position 58 (FIG. 2). As used in this specification and the appended claims, “take-up position” means a spindle position for moving media onto a reel after printing. The drum end 22 to which the spindle actuators 46 attach includes three apertures, one for each spindle actuator 46. Each aperture allows a pinion 50 to extend through the drum end 22, in order that the pinion 50 may simultaneously engage a circular rack 48 that is inside the drum 16 and a first spindle motor 52 or second spindle motor 56 that is outside the drum end 22 and mounted to the chassis 20.

In another embodiment, each spindle actuator 46 may include a dedicated motor that engages the pinion 50 of that spindle 28. In such an embodiment, a dedicated motor might be used to actuate the spindle 28 when such spindle 28 is in a feeding position 54 or a take-up position 58.

Movements of the spindle actuators 46 are controlled by one or more controllers 44 (FIG. 9) that electronically connect to the first spindle motor 52 and the second spindle motor 56. In an embodiment, the first spindle motor 52 and the second spindle motor 56, working in concert with the spindle actuators 46, can rotate the spindles 28 in either a clockwise or a counterclockwise direction. The controller 44 may control the first spindle motor 52 in a manner such that the first spindle motor 52 provides mechanical resistance to a spindle 28 in the feeding position 54, and thereby control the speed of the spindle 28 and the feeding of media 61 (FIG. 7) through a media path 12. The first spindle motor 52 may also be used to advance media 61 through the media path 12 to a driving wheel 62 (FIG. 7).

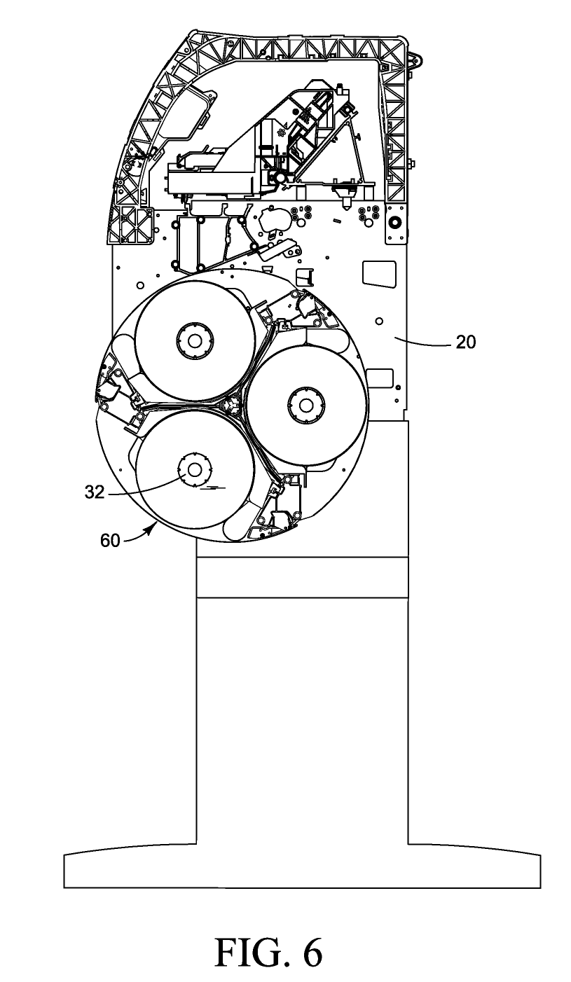

FIG. 6 is a cross-section diagram of the apparatus of FIG. 3, illustrating a spindle in a loading/unloading position. In the exemplary embodiment a first spindle 32 holds a media roll 10 (FIG. 3), and the drum 16 is positioned such that the first spindle 32 is in a loading/unloading position 60. As used in this specification and the appended claims, “loading/unloading position” means a spindle position for inserting or removing a media roll or a reel from a drum. When the first spindle 32 is in a loading/unloading position 60, a user can access and remove a media roll 10 or reel 14 (FIG. 3) that is being held by the first spindle 32, and replace the removed media roll 10 or reel 14 with a new media roll 10 or reel 14 (FIG. 3). In an embodiment, the drum 16 includes a removable cover that remains closed during printing operations, and is opened during loading and unloading operations to provide a user with access to a media roll 10 or reel 14.

FIG. 7 is a cross-section diagram of the apparatus of FIG. 3, illustrating a media path 12. In the exemplary embodiment the printhead 4, the carriage 6 and the scan axis 8 are positioned at the top of the printing device 2. Three spindles 28 attach to the drum 16, each spindle 28 capable of holding a media roll 10 (FIG. 3) containing different types of media, or a reel 14 (FIG. 3). By precisely rotating the drum 16, a user can position a particular spindle 28 in a feeding position 54 or a take-up position 58 and enables many printing combinations. A driving wheel 62, attached to the chassis 20, engages media 61 and moves media 61 off a media roll 10 that is held by a spindle 28 in a feeding position 54 and through a media path 12 so as to pass under the printhead 4 for printing. A driving wheel motor 78 (FIG. 9) that is attached to the chassis 20 causes movement of the driving wheel 62. In an embodiment three pinch rollers 64 attach to the drum 16, each pinch roller 64 associated with a different spindle 28, for holding media 61 taut in a media path 12 when the associated spindle 28 is in the feeding position 54.

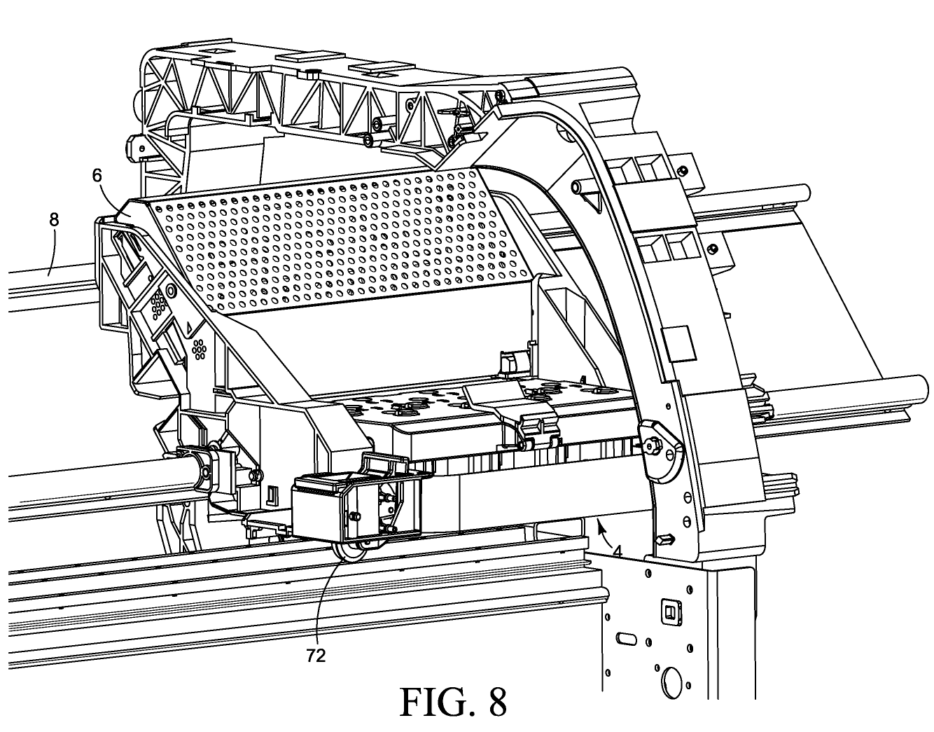

For example, a user might elect to place a media roll 10 containing plain paper media onto the first spindle 32, a reel 14 onto a spindle two 34, and a media roll 10 of glossy paper media onto a third spindle 66. The user could elect via a user interface to print on plain paper media from a media roll 10 that is held by the first spindle 32. A controller 44 would move the first spindle 32 into a feeding position 54, and take up the printed-upon media 63 onto the reel 14 that is held by the second spindle 34 that is in a take-up position 58. In an embodiment, the first spindle 32 rotates in a counterclockwise direction 68 as it feeds media 61 through the media path 12, and the second spindle 34 takes-up the printed-upon media 63 from the media path 12 by rotating in a clockwise direction 70. The user might then choose to switch to printing on glossy media by taking the following steps: cutting the plain paper media that is in the media path 12 by operation of a cutter 72 (FIG. 8) that is attached to the carriage 6, moving the first spindle 32 to a loading/unloading position 60 (FIG. 6) in which the plain paper roll can be removed and replaced with a reel 14, and then rotating the drum 16 such that the first spindle 32 (at this point holding a reel 14) moves to the take-up position 58 and the third spindle 66 (at this point holding a roll of glossy media) moves to the feeding position 54. At this point the printing device is ready for printing on the glossy media.

As another example, a user might elect to place a roll of banner paper media onto the first spindle 32, a reel 14 onto the second spindle 34, and a second reel onto the third spindle 66. The user could select via a user interface to duplex print, and the controller 44 would move the first spindle 32 into a feeding position 54, and take up the printed-upon media 63 onto the reel 14 that is held by the second spindle 34 that is in a take-up position 58. At the end of the first-side printing operation, second-side printing would be enabled via the following steps: cutting the banner media that is in the media path 12 by operation of a cutter 72 (FIG. 8) that is attached to the carriage 6, discharging the printed upon media 63 from the media path 63 by rotating clockwise the second spindle 34, discharging the media 61 from the media path 12 by rotating clockwise the first spindle 32, rotating the drum 16 so that the second spindle 34 (which at this point holds the reel 14 that holds the printed-upon banner media) is in a feeding position 54 and the third spindle 66 (which holds an empty reel 14 (FIG. 3)) is in a take-up position 58. At this point the printing device is ready for reverse-side printing on the banner media. During the reverse-side printing process media 61 would be fed by the second spindle through the media path 12 and beneath the printhead 4, and then collected onto a reel 14 held by the third spindle 66.

Many other configurations and combinations are possible, to be chosen by the user depending upon the priorities of the project at hand (e.g. speed, minimizing movement of rolls of media 10, immediate need to retrieve printed-upon media 63, etc.).

FIG. 8 is a cutaway diagram of the apparatus of FIG. 3, illustrating a cutter 72. In an embodiment a cutter 72 is attached to the carriage 6, the cutter 72 including a blade that is in a retracted state during printing and other operations not involving cutting and is in an extended state during a cutting operation. During a cutting operation the cutter's blade extends to a degree that the blade engages the media 61 (FIG. 7). A carriage motor 74 (FIG. 9) that is attached to the chassis 20 may move the carriage 6 and cutter 72 along the scan axis 8 in a direction parallel to the long axis of the media roll 10 (FIG. 3), and cause the extended blade to engage and cut media 61.

FIG. 9 is a block diagram of the apparatus of FIG. 3. In this example a single controller 44 electronically connects with a drum motor 42, a first spindle motor 52, a second spindle motor 56, a driving wheel motor 78, and a carriage motor 74. The controller 44 includes a processor 80 and a memory 82. The exemplary controller 44 may represent one or multiple controllers 44, with each controller 44 having one or multiple processors and one or multiple memories. The controller 44 may include a number of software components that are stored in a computer-readable medium, such as memory 82, and are executable by a processor 80. As used in this specification and the appended claims, “memory” includes an electronic storage location for instructions and data. As used in this specification and the appended claims, “processor” includes logic circuitry that responds to and processes instructions so as to control a system. In this respect, the term “executable” includes a program file that is in a form that can be directly (e.g. machine code) or indirectly (e.g. source code that is to be compiled) performed by a processor. An executable program may be stored in any portion or component of memory 82.

In an embodiment the controller 44 electronically connects to an optical sensor 84. The optical sensor 84 is configured to capture images and measure distances so as to detect the position of media 61 (FIG. 7), and convey the positional information to the controller 44. As used in the present specification and in the appended claims, the term “optical sensor” includes a device that captures a digital image of a target, which may be physical characteristic or other reference point on the media. In an embodiment the controller 44 is configured to determine the precise motion of the media 61 from images received from the optical sensor 84. This information is used by the controller 44 to control movement of the spindles 28 via the first spindle motor 52 and the second spindle motor 56 during feeding, taking up and duplexing operations. During a duplexing operation, the controller 44 may also utilize the positional information to control movement of the media 61 via a driving wheel motor 78, so as to precisely align the image to be printed on the reverse side of the media 61 relative to the image previously printed on the front side of the media 61. In an embodiment an optical sensor 84 may be configured to capture images and measure distances so as to detect the position of printed-upon media 63 (FIG. 7), and convey the positional information to the controller 44.

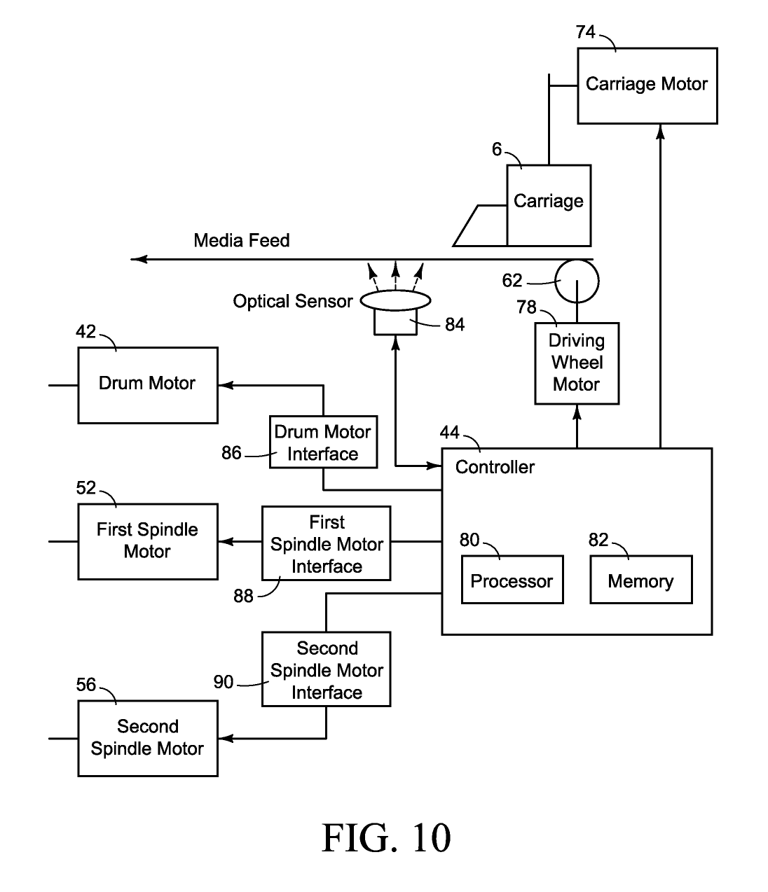

FIG. 10 is a block diagram of the apparatus of FIG. 3, illustrating a drum motor interface, a first spindle motor interface and a second spindle motor interface. In this example a single controller 44 electronically connects, indirectly via a drum motor interface 86, with a drum motor 42. The controller 44 electronically connects, indirectly via a first spindle motor interface 88, with a first spindle motor 52. The controller 44 electronically connects, indirectly via a second spindle motor interface 90, with a second spindle motor 56. The controller 44 connects directly with a driving wheel motor 78 and a carriage motor 74. As used in this specification and the appended claims, “interface” suggests architecture used to connect two or more hardware elements, including connections to pass electrical signals between such elements. In an example, the drum motor interface 86, the first spindle motor interface 88 and the second spindle motor interface 90 may be of the plug and socket design such that the hardware elements may be separated.

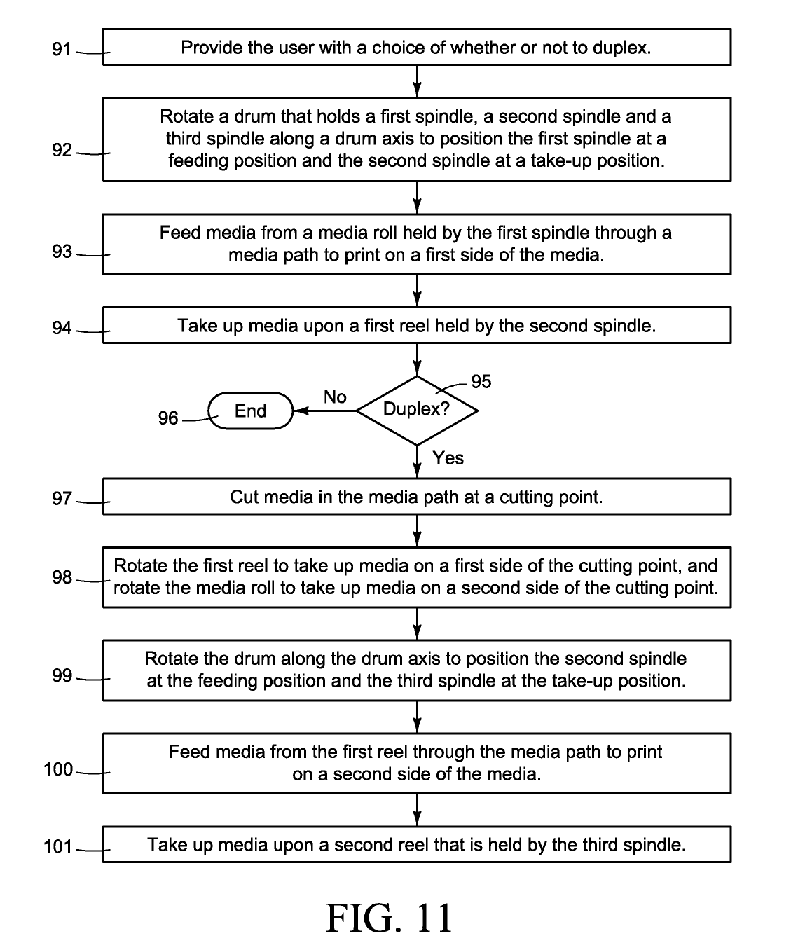

FIG. 11 is a flow chart of one embodiment of a method for feeding, taking up and duplexing. The method begins at block 91, in which the user of a printing device that prints on roll media is provided with a choice of whether or not to duplex print. In an embodiment the user is provided a choice regarding duplexing, and designates his or her choice, via a printing device user interface or, or via a connected computer, for example by operation of a printing device driver. The information regarding the user's choice regarding duplexing is sent from the user interface to the controller, and may be stored in memory.

The method continues at block 92, in which a drum that holds a first spindle, a second spindle and a third spindle is rotated along a drum axis to position the first spindle at a feeding position and the second spindle at a take-up position. Rotation of the drum can be controlled by operation of a drum motor and a controller that electronically connects to the drum motor.

The method continues at block 93, in which media is fed from a media roll held by the first spindle through a media path to print on a first side of the media. Rotation of the first spindle can be controlled by operation of a first spindle motor and a controller that electronically connects to the first spindle motor.

The method continues at block 94, in which media is taken up upon a first reel held by the second spindle. Rotation of the second spindle can be controlled by operation of a second spindle motor and a controller that electronically connects to the second spindle motor.

The method continues at block 95. The controller may access memory to retrieve the user's choice regarding duplexing. If the user chose not to duplex, the method ends at block 96 as first side printing is complete. If the user chose to duplex, the following steps occur: a) media in the media path is cut at a cutting point (block 97); b) the first reel rotates to take up media from the media path on a first side of the cutting point, and the media roll rotates to take up the media from the media path on a second side of the cutting point (block 98); c) the drum is rotated along the drum axis to position the second spindle at the feeding position and the third spindle at the take-up position (block 99); d) media from the first reel is fed through the media path to print on a second side of the media (block 100); and e) the media (at this point with printed images on both the first and second sides) is taken-up on a second reel (block 101) that is held by the third spindle. In an embodiment the controller may at this point send a signal to the drum motor to cause the drum to rotate to move the third spindle to a loading/unloading position and prompt the user to unload the second reel holding the duplexed media. In an embodiment there may be additional steps, including detecting the position of media during duplexing by operation of an optical sensor.

The preceding description has been presented only to illustrate and describe embodiments and examples of the principles described. This description is not intended to be exhaustive or to limit these principles to any precise form disclosed. Many modifications and variations are possible in light of the above teaching.

1. An apparatus, comprising:
a drum axis;
a drum connecting to the drum axis, the drum to hold spindles and to rotate around the drum axis to position spindles;
three spindles connecting to the drum, each spindle to hold a media roll or a reel to feed, take up or duplex media; and
a first reel, removably connecting to one of the three spindles.

2. The apparatus of claim 1, further comprising a second reel, removably connecting to one of the three spindles.

3. The apparatus of claim 1, further comprising three rotating members connecting to the drum.

4. The apparatus of claim 1, wherein each of the three spindles is positioned on the drum approximately equidistant from the drum axis and approximately equidistant from adjacent spindles.

5. The apparatus of claim 1, wherein the three spindles comprise exactly three spindles.

6. The apparatus of claim 1, further comprising a driving wheel connecting to a chassis, to drive media through a media path.

7. (canceled)

8. The apparatus of claim 1, further comprising a cutter connecting to a carriage, the cutter to cut media.

9. The apparatus of claim 1, further comprising a drum actuator connecting to a chassis, the drum actuator to engage and rotate the drum.

10. The apparatus of claim 9,
wherein the drum actuator comprises a drum motor,
and the apparatus further comprising a drum motor interface that electronically connects to the drum motor, the drum motor interface to communicate with a controller.

11. The apparatus of claim 9,
wherein the drum actuator comprises a drum motor,
and the apparatus further comprising a controller that electronically connects to the drum motor, the controller to control movement of the drum motor.

12. The apparatus of claim 1, further comprising:
three spindle actuators, each connecting to the drum and to a different one of the three spindles, and each to engage and actuate a different one of the three spindles;
a first spindle motor that connects to a chassis, to engage and move a spindle actuator connecting to a spindle that is in a feeding position; and
a second spindle motor that connects to the chassis, to engage and move a spindle actuator connecting to a spindle that is in a take-up position.

13. The apparatus of claim 12, further comprising:
a first spindle motor interface that electronically connects to the first spindle motor, the first spindle motor interface to communicate with a controller; and
a second spindle motor interface that electronically connects to the second spindle motor, the second spindle motor interface to communicate with a controller.

14. The apparatus of claim 12, further comprising a controller that electronically connects to the first spindle motor and the second spindle motor, the controller to control movement of the first spindle motor and the second spindle motor.

15. The apparatus of claim 12, further comprising an optical sensor, the optical sensor to connect to a controller and to detect position of media.

16. A method, the method comprising:
rotating a drum that holds a first spindle, a second spindle and a third spindle along a drum axis to position the first spindle at a feeding position and the second spindle at a take-up position;
feeding a first media from a first media roll held by the first spindle through a media path to print on a first side of the first media; and
taking up the first media upon a first reel held by the second spindle.

17. The method of claim 16, further comprising:
controlling rotation of the drum by operation of a drum motor and a controller that electronically connects to the drum motor;
controlling rotation of the first spindle at the feeding position by operation of a first spindle motor and a controller that electronically connects to the first spindle motor; and
controlling rotation of the second spindle at the take-up position by operation of a second spindle motor and a controller that electronically connects to the second spindle motor.

18. The method of claim 16, further comprising:
providing the user with a choice of whether or not to duplex;
if the user chooses to duplex, performing a duplexing function comprising
rotating the drum along the drum axis to position the second spindle at the feeding position and the third spindle at the take-up position,
feeding the first media from the first reel through the media path to print on a second side of the first media, and
taking up the first media upon a second reel that is held by the third spindle.

19. The method of claim 18, further comprising detecting a position of the first media during duplexing by operation of an optical sensor.

20. An apparatus, comprising:
a drum axis;
a drum connecting to the drum axis, the drum to hold spindles and to rotate around the drum axis to position spindles;
three spindles connecting to the drum, each spindle to hold a media roll or a reel to feed, take up or duplex media;
a reel, removably connecting to one of the three spindles;
a drum actuator connecting to a chassis and engaging the drum, the drum actuator to rotate the drum, and the drum actuator comprising a drum motor;
three spindle actuators, each connecting to the drum and to a different one of the three spindles, and each to engage and actuate a different one of the three spindles;
a first spindle motor that connects to a chassis, to engage and move a spindle actuator connecting to a spindle that is in a feeding position;
a second spindle motor that connects to a chassis, to engage and move a spindle actuator connecting to a spindle that is in a take-up position; and
a controller that electronically connects to the drum motor, the first spindle motor and the second spindle motor, the controller to control the movement of the drum motor, the first spindle motor and the second spindle motor.

21. The method of claim 16, further comprising:
moving the first spindle to a loading/unloading position;
replacing the first media roll that is held by the first spindle with a second reel;
rotating the drum such that the first spindle moves to the take-up position and the third spindle that holds a second media moves to the feeding position;
feeding the second media from the third spindle through the media path to print on the second media, and
taking up the second media upon the second reel held by the first spindle.
